(19) United States
(12) Patent Application Publication
(10) Pub. No.: US 2019/0242424 A1
(43) Pub. Date: Aug. 8, 2019

(54) SNAP-IN RETENTION NUT

(71) Applicant: ILLINOIS TOOL WORKS INC., Glenview, IL (US)

(72) Inventors: David G. Gugin, Twin Lake, MI (US); Ronald C. Owens, II, Lawrenceburg, KY (US)

(21) Appl. No.: 16/267,595

(22) Filed: Feb. 5, 2019

Related U.S. Application Data
(60) Provisional application No. 62/626,190, filed on Feb. 5, 2018.

(51) Int. Cl. F16B 33/00; F16B 37/08; F16B 37/14; F16B 39/00; F16B 41/00

(52) U.S. Cl. CPC F16B 33/002; F16B 37/08; F16B 33/004; F16B 39/00; F16B 41/002; F16B 37/14

(57) ABSTRACT

A retention nut includes a fastening portion and a mating portion. The fastening portion has internal threads. The mating portion is connected to the fastening portion and includes a snap wing.

### RELATED APPLICATION

This application claims the benefit of U.S. Provisional Application No. 62/626,190 filed on Feb. 5, 2018, which is hereby incorporated by reference in its entirety.

### FIELD OF THE DISCLOSURE

This disclosure relates generally to threaded fittings, and, more particularly, to snap-in retention nuts.

### BACKGROUND

In recent years, drain nuts have been developed to secure to a component (such as an oil pan) and mate with a reciprocal drain plug to selectively drain fluid from the component. When the drain plug is secured to the drain nut, fluid is prevented from passing through the drain nut. When the drain plug is removed from the drain nut, fluid is able to pass through the drain nut.

Certain known drain nuts are secured to components or substrates through a welding process. Because robotic welding devices are typically used to weld the drain nuts to the components, welding is an expensive investment from a manufacturing standpoint. Moreover, because welding has a tendency to deform the component or substrate, the temperature and timing of the welding process is closely monitored and controlled to produce robust welds without damaging the component or substrate.

Additionally, in many applications (such as with oil pans for vehicles), the substrate may be formed of aluminum. However, because aluminum has a relatively low melting point, welding may be an unsuitable method to attach drain nuts to aluminum substrates. As an alternative to welding, a drain nut may be crimped or swaged into an opening of a component. Machinery to perform the crimping/swaging process is also an expensive investment from a manufacturing standpoint.

Therefore, a need exists for a drain nut that may be quickly and efficiently secured into an opening of a component. Further, a need exists for a drain nut that may be secured to a component without automated machinery, tooling, or welding.

### SUMMARY

In one aspect, a retention nut is disclosed, which includes a fastening portion and a mating portion. The fastening portion has internal threads. The mating portion is connected to the fastening portion and includes a snap wing.

In a different aspect, another retention nut is disclosed, which includes an internally threaded fastening portion, a snap wing, and a flange tab. The snap wing is connected to the fastening portion. The flange tab is connected to the fastening portion.

In yet another aspect, another retention nut is disclosed, which includes a barrel, a transitional slope, a snap wing, a non-circular base, and a flange tab. The transitional slope is connected to the barrel. The snap wing extends outwardly from the transitional slope. The non-circular base is connected to the transitional slope. The flange tab extends outwardly from the base.

### BRIEF DESCRIPTION OF THE DRAWINGS

FIG. 1 is an isometric view of a first example drain plug retention nut, according to one exemplary embodiment;

FIG. 2 is a bottom isometric view of the retention nut of FIG. 1;

FIG. 3 is a side elevational view of the retention nut of FIGS. 1 and 2;

FIG. 4 is another side elevational view of the retention nut of FIGS. 1-3;

FIG. 5 is an isometric view of the retention nut of FIGS. 1-4 and a cutaway portion of a pan;

FIG. 6 is a side elevational view of the retention nut of FIGS. 1-5 as installed in the pan of FIG. 5;

FIG. 7 is another side elevational view of the retention nut of FIGS. 1-6 as installed in the pan of FIGS. 5 and 6;

FIG. 8 is a cross-sectional isometric view of the retention nut of FIGS. 1-7 as installed in the pan of FIGS. 5-7, taken along the line 8-8 of FIG. 6;

FIG. 9 is another cross-sectional isometric view of the retention nut of FIGS. 1-8 as installed in the pan of FIGS. 5-8, taken along the line 9-9 of FIG. 7;

FIG. 10 is an isometric view of the retention nut of FIGS. 1-9 and a plug assembly as installed in the pan of FIGS. 5-9;

FIG. 11 is a cross-sectional view of the retention nut of FIGS. 1-10 and the plug assembly of FIG. 10 as installed in the pan of FIGS. 5-10, taken along the line 11-11 of FIG. 10;

FIG. 12 is an isometric view of a second example drain plug retention nut, according to another exemplary embodiment;

FIG. 13 is an isometric view of the retention nut of FIG. 12 as installed in the pan of FIGS. 5-11 and engaged with a cutaway portion of a cover;

FIG. 14 is a cross-sectional view of the retention nut of FIGS. 12 and 13 as installed in the pan of FIGS. 5-11 and 13 and engaged with the cover of FIG. 13, taken along the line 14-14 of FIG. 13;

FIG. 15 is a cross-sectional isometric view of the retention nut of FIGS. 12-14 as installed in the pan of FIGS. 5-11, 13, and 14 and engaged with the cover of FIGS. 13 and 14, taken along the line 15-15 of FIG. 13;

FIG. 16 is an isometric view of the retention nut of FIGS. 12-15 and a screw as installed in the pan of FIGS. 5-11 and 13-15 and engaged with the cover of FIGS. 13-15; and

FIG. 17 is a cross-sectional isometric view of the retention nut of FIGS. 12-16 and the screw of FIG. 16 as installed in the pan of FIGS. 5-11 and 13-16 and engaged with the cover of FIGS. 13-16, taken along the line 17-17 of FIG. 16.

### DETAILED DESCRIPTION

As explained herein, the present disclosure provides a retention nut that may be quickly and efficiently secured into an opening of a component without automated machinery, tooling, or welding. As a non-limiting example, the retention nut may be configured to mechanically snap into a non-circular opening of a mating component, e.g., a tank, a sump, an oil pan, etc. The retention nut may be shaped to accept an associated drain plug to selectively allow fluid to drain through the drain plug retention nut, e.g., when draining oil from a vehicle. The retention nut exhibits a low insertion force and includes a locking feature that provides the retention nut with a high extraction force.

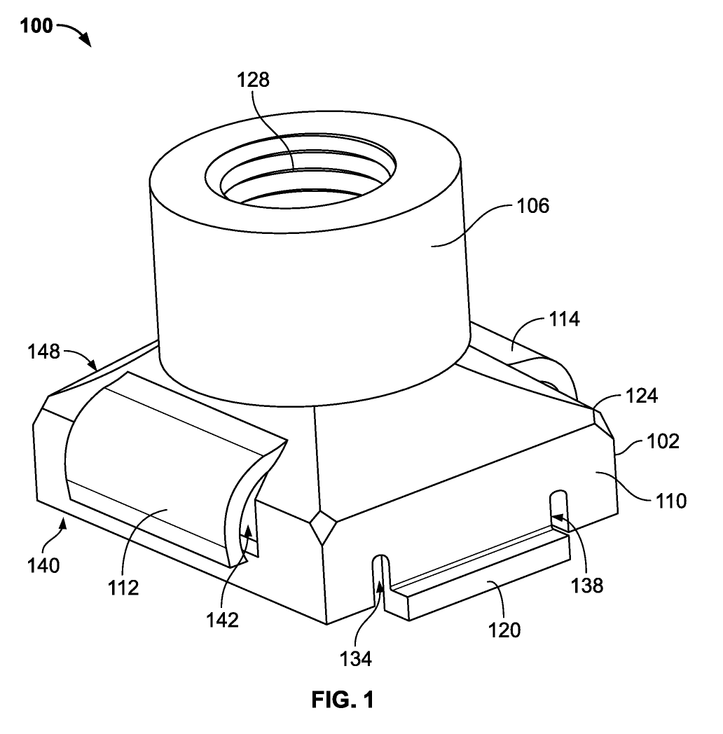

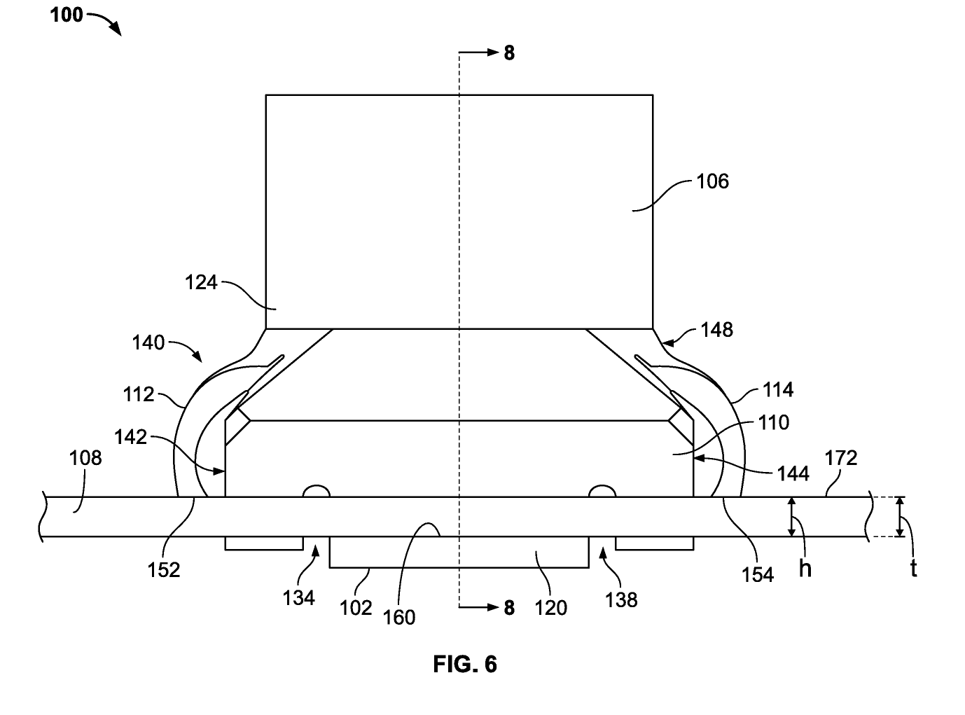

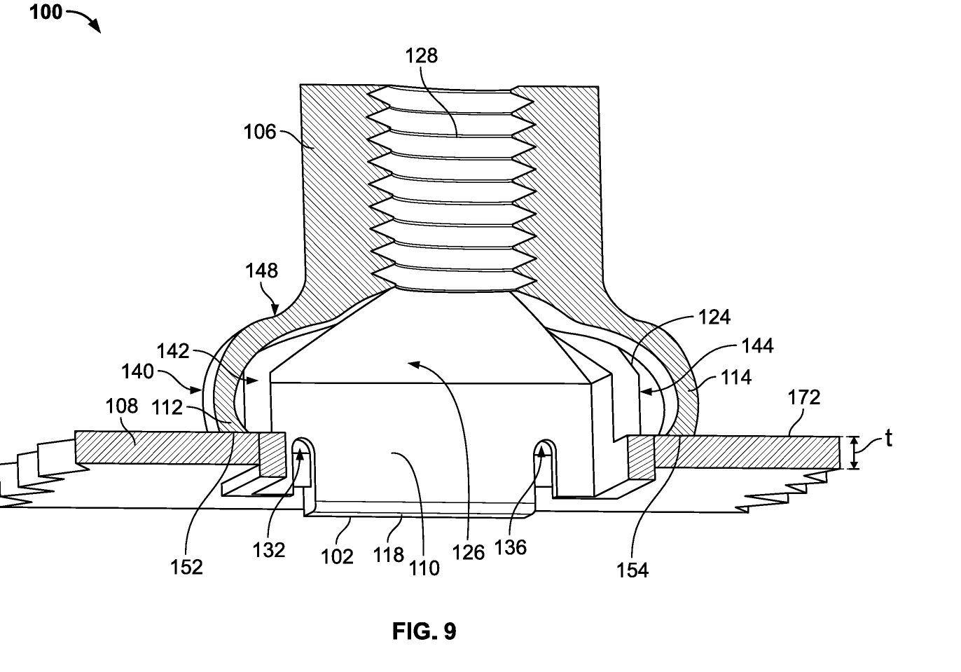

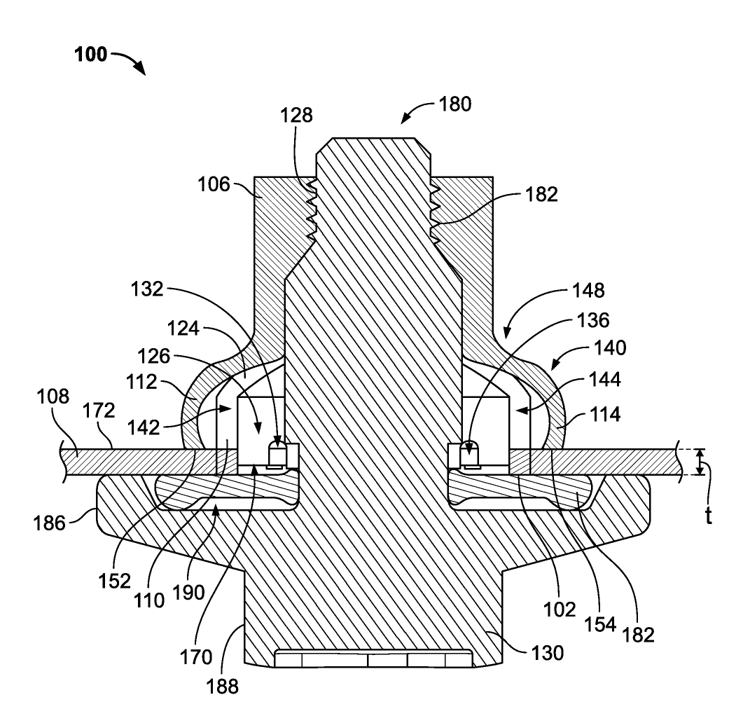

With reference to FIGS. 1-11, a first example retention nut 100 includes a mating portion 102 and a fastening portion 106. The mating portion 102 is configured to snapably engage with a component 108, as shown in FIGS. 6-11. Turning specifically to FIGS. 1-4, the mating portion 102 includes a base 110, a first snap wing 112, a second snap wing 114, a first flange tab 118, a second flange tab 120, and a slope 124. The fastening portion 106 is connected to the mating portion 102 via the slope 124. The base 110 is connected to the slope 124. In the example embodiment, the fastening portion 106 is a barrel. It should be understood that the fastening portion 106 may be any internally threaded structure connected to the base 110. The base 110, the slope 124, and the fastening portion 106 define an internal void 126. The fastening portion 106 includes internal threads 128 to threadably engage with a drain plug assembly 130, as shown in FIG. 11. In other words, the fastening portion 106 is internally threaded. In some embodiments, the internal threads 128 are formed as a thread-engaging crimp in the fastening portion 106.

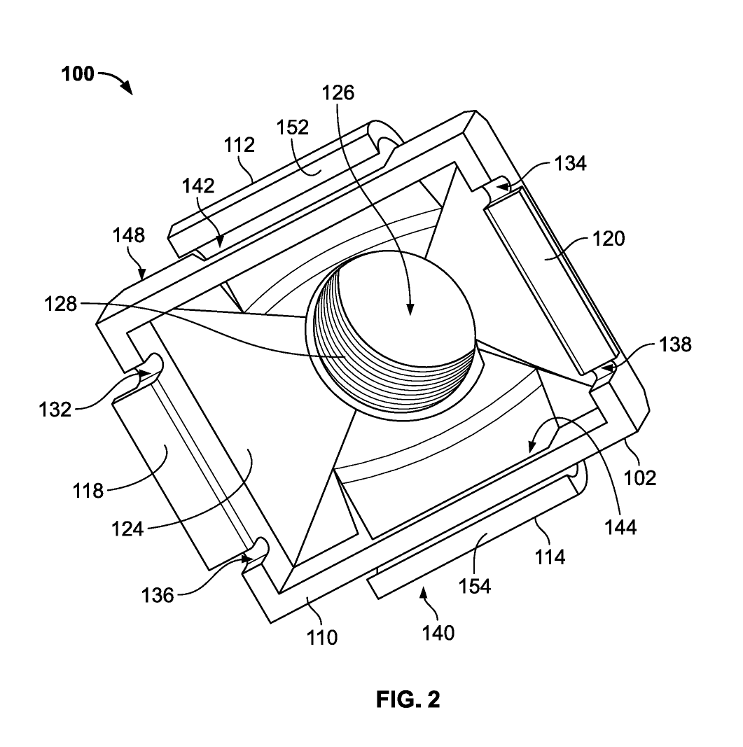

With particular reference to FIG. 2, the fastening portion 106 is generally smaller in cross-sectional area than the base 110. Thus, the slope 124 provides a connecting transition between the base 110 and the fastening portion 106. In the example of FIGS. 1-11, the base 110 is four-sided. Thus, the slope 124 is correspondingly pyramidal. It should be understood that the base 110 may be any non-circular shape, e.g., polygonal, ovular, etc., and that the slope 124 may be any corresponding transitional shape, e.g., pyramidal, domed, etc.

With reference to FIGS. 1-3, 5, 6, and 9-11, the first snap wing 112 and the second snap wing 114 extend outwardly from the slope 124. In the present embodiment, the first snap wing 112 and the second snap wing 114 are arcuate, extend outwardly from the slope 124, and oppose one another. The first snap wing 112 and the second snap wing 114 are flexibly rotatable relative to the slope 124. It should be understood that the first snap wing 112 and the second snap wing 114 are depicted in an uncompressed position 140 in FIGS. 1-11.

With reference to FIGS. 2, 4, 5, 7, and 8 the first flange tab 118 and the second flange tab 120 extend outwardly from the base 110 and oppose one another. The first and second flange tabs 118, 120 are rotationally alternate with the first and second snap wings 112, 114, as shown in FIG. 2. In other words, the first and second flange tabs 118, 120 are between the first and second snap wings 112, 114 and vice versa.

With reference to FIG. 2, the base 110 defines a first slot 132, a second slot 134, a third slot 136, and a fourth slot 138. The first slot 132 opposes the second slot 134. The third slot 136 opposes the fourth slot 138. The first flange tab 118 extends between the first slot 132 and the third slot 136. The second flange tab 120 extends between the second slot 134 and the fourth slot 138. The first slot 132, the second slot 134, the third slot 136, and the fourth slot 138 are in fluid communication with the internal void 126.

With reference to FIGS. 2, 5, 9, and 11, the base 110 and the slope 124 define a first opening 142 and a second opening 144. The first opening 142 opposes the second opening 144. The first opening 142 and the second opening 144 are in fluid communication with the internal void 126. It should be understood that the first opening 142 and the second opening 144 may be respectively formed when the first snap wing 112 and the second snap wing 114 are stamped from the mating portion 102. Thus, an exterior 148 of the retention nut 100 is in fluid communication with the internal void 126 via the first, second, third, and fourth slots 132, 134, 136, 138 and the first and second openings 142, 144.

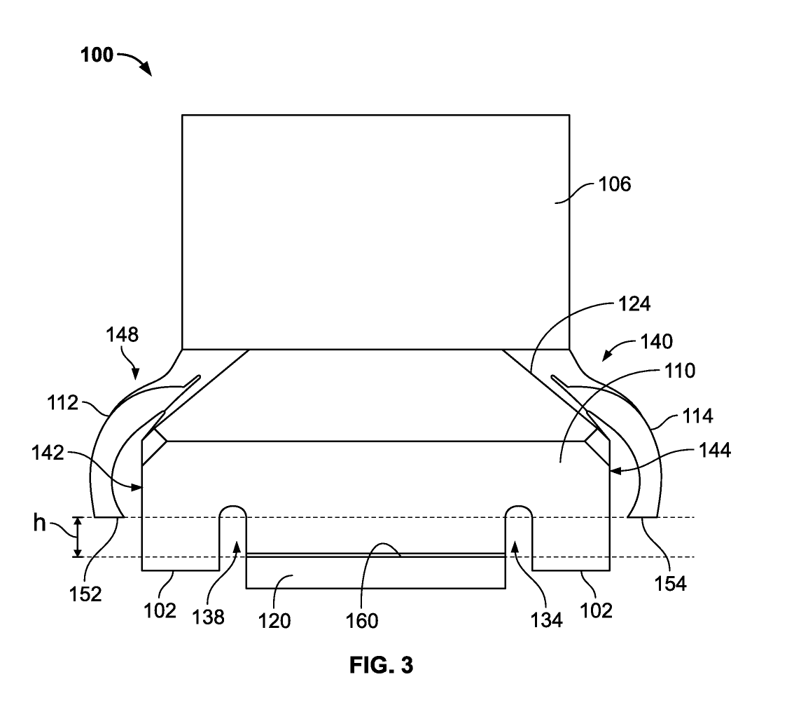

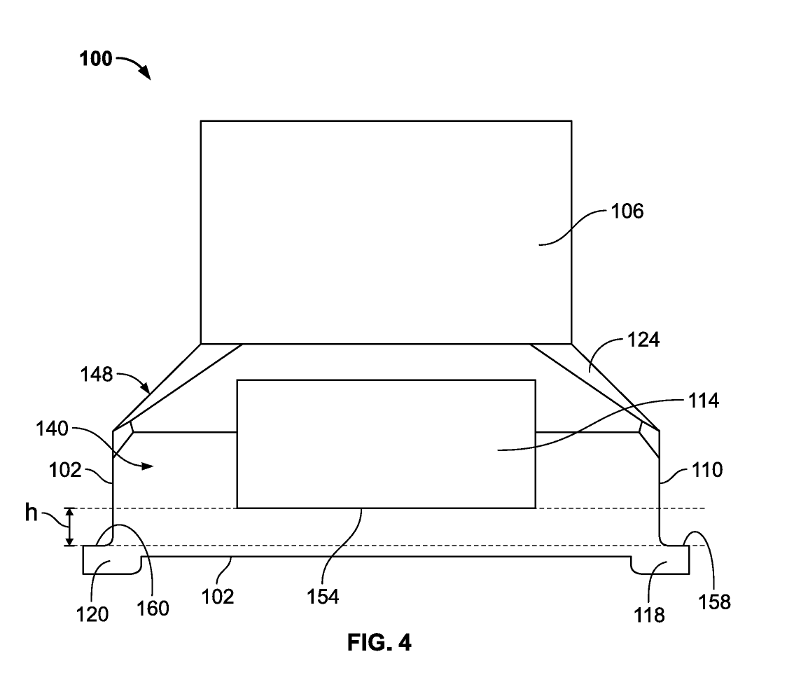

With reference to FIGS. 3, 6, 9, and 11, the first snap wing 112 has a first end 152 and the second snap wing 114 has a second end 154. The first end 152 and the second end 154 are generally coplanar. Looking at FIGS. 4, 7, and 8, the first flange tab 118 has a first upper surface 158 and the second flange tab 120 has a second upper surface 160. The first upper surface 158 and the second upper surface 160 are generally coplanar. Thus, the first snap wing 112, the second snap wing 114, the first flange tab 118, and the second flange tab 120 define a height difference h between the first and second ends 152, 154 and the first and second upper surfaces 158, 160, as shown in FIGS. 3, 4, 6, and 7.

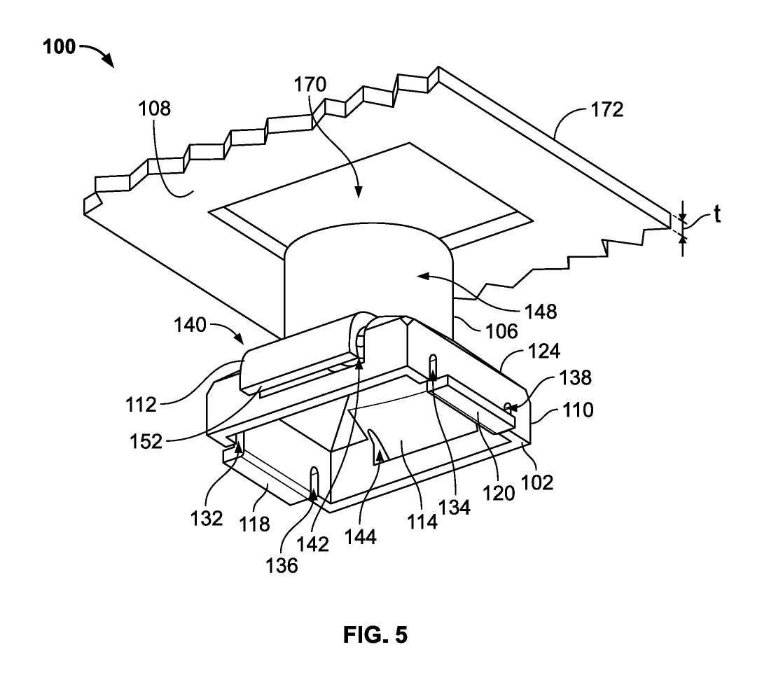

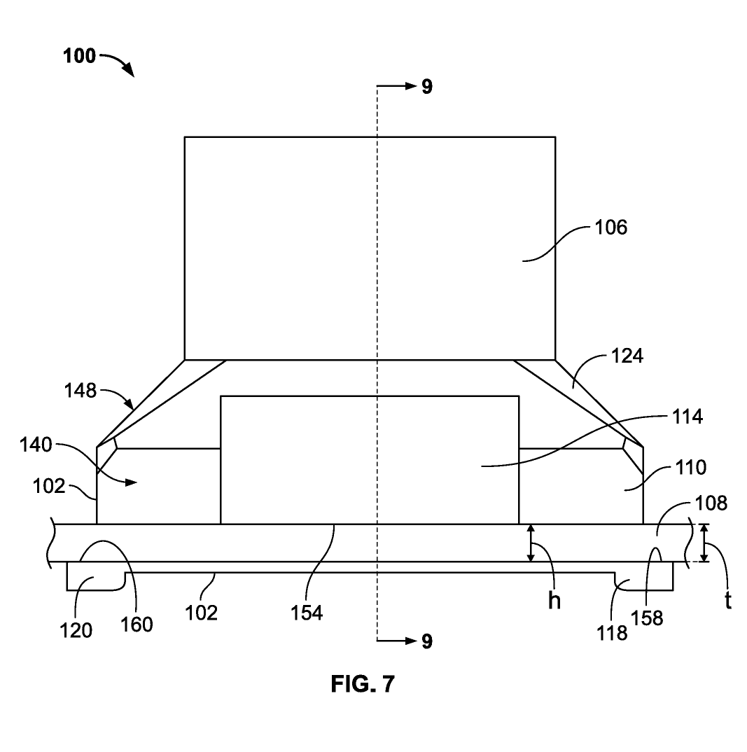

With reference to FIG. 5, the component 108 defines an opening 170 and has a thickness t. In the example embodiment, the opening 170 is four-sided to receive the four-sided base 110. It should be understood the that first and second snap wings 112, 114 and the first and second flange tabs 118, 120 are configured such that the height difference h is equal to (e.g., matches) or is slightly greater than the thickness t, as shown in FIGS. 6 and 7. It should be appreciated that the retention nut 100 may be configured during manufacturing to define any height difference h. Additionally, the component 108 has an internal bottom 172, as shown in FIGS. 5-11.

With reference to FIG. 11, the drain plug assembly 130 includes a screw plug 180 and a sealing disk 182. The screw plug 180 includes a shank 184, a compression flange 186, a tightening cap 188, and external threads 190. The compression flange 186 defines a well 192. The sealing disk 182 is generally annular and is disposed about the shank 184 and in the well 192. The sealing disk 182 is sized to overshadow the opening 170.

With reference to FIGS. 5-11, in operation, the retention nut 100 is inserted through the opening 170 to seat the mating portion 102 in the component 108. More specifically, as the retention nut 100 is pushed into the opening 170, the first and second snap wings 112, 114 contact the component 108 and deflect toward one another. Further in operation, after the first and second snap wings 112, 114 pass through the opening 170, the first and second snap wings 112, 114 deflect resiliently outwardly away from one another to the uncompressed position 140. In other words, the first and second snap wings 112, 114 snap back to the uncompressed position 140 after squeezing through the opening 170. It should be appreciated that the first and second snap wings 112, 114 may be inserted through the opening 170 by hand. Additionally in operation, the first and second flange tabs 118, 120 provide a hard stop to prevent the retention nut 100 from being pushed entirely through the opening 170. Thus, when then retention nut 100 is seated in the component 108, the first and second ends 152, 154 and the first and second upper surfaces 158, 160 contact the component. In other words, when the retention nut 100 is secured in the component 108, the component 108 is between the first and second snap wings 112, 114, and the first and second flange tabs 118, 120.

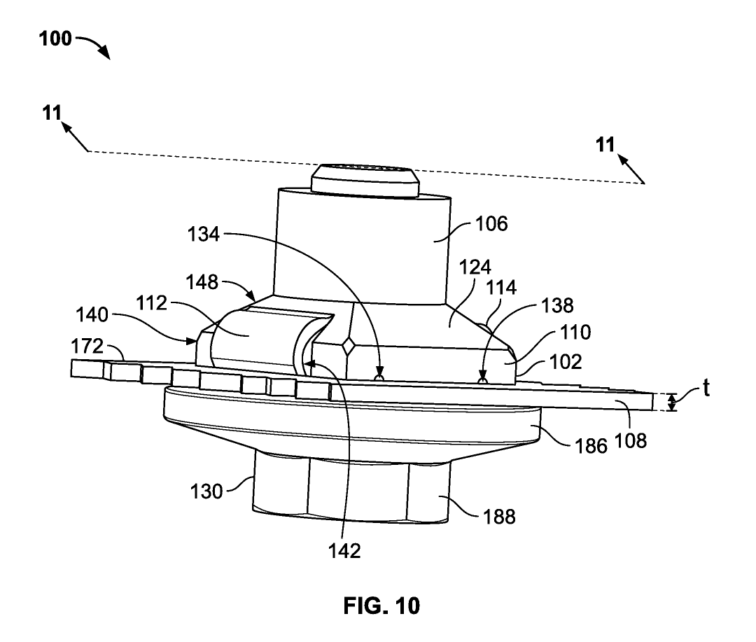

With reference to FIGS. 10 and 11, in operation, the drain plug assembly 130 is inserted into the retention nut 100 to seal the opening 170. More specifically, in operation, the screw plug 180 is threadably engaged with the fastening portion 106 via the external threads 190 and the internal threads 128, as shown in FIG. 11. As the screw plug 180 is tightened via the tightening cap 188, e.g., with a hex socket tool, the compression flange 186 compresses the sealing disk 182 against the component 108. Thus, the sealing disk 182 is disposed between and sealingly engages the component 108 and the compression flange 186. It should be appreciated that because the mating portion 102 and the opening 170 are non-circular, the component 108 provides a reaction force against which the drain plug assembly 130 may be tightened. In other words, the correspondingly non-circular opening 170 and mating portion 102 prevent the retention nut 100 from spinning in the component 108 when the screw plug 180 is turned.

With reference to FIGS. 1, 2, 8, and 9, it should be understood that the retention nut 100 may be used with any threaded fastener in addition or alternatively to the drain plug assembly 130 depicted in FIGS. 10 and 11. It should also be understood that threaded fasteners may be engaged with the fastening portion 106 directly or via the mating portion 102. Thus, the retention nut 100 may be used in any application that calls for a threaded boss in the component 108.

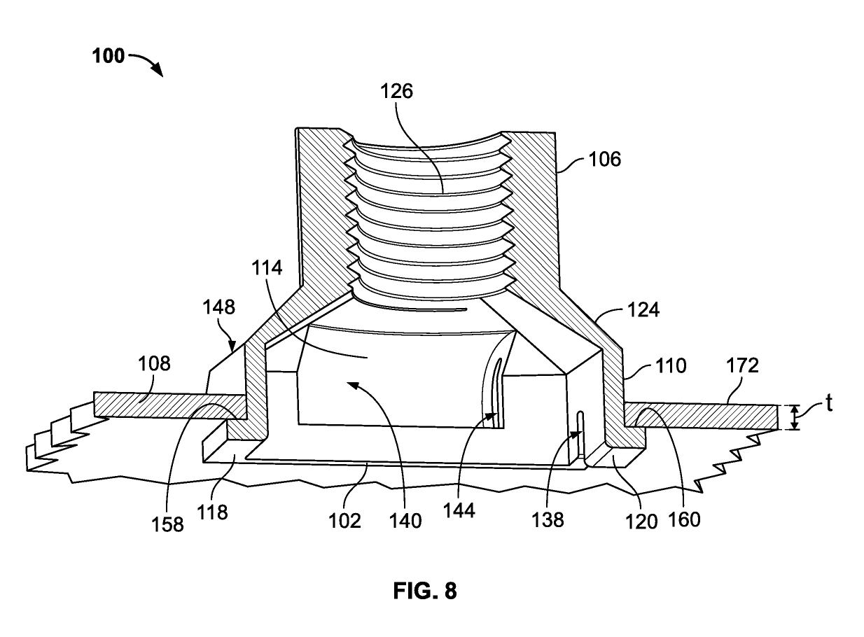

With reference to FIGS. 8, 9, and 11, it should be understood and appreciated that the exterior 148 remains in fluid communication with the internal void 126 via the first, second, third, and fourth slots 132, 134, 136, 138 and the first and second openings 142, 144 when the retention nut 100 is seated in the component 108. Thus, the exterior 148 remains in fluid communication with the internal void 126 when the drain plug assembly 130 is installed in the seated retention nut 100, as shown in FIG. 11. In operation, once the drain plug assembly 130 is threaded into the seated retention nut 100 and tightened against the component 108, the component 108 may be filled with a fluid, e.g., oil. When the component 108 is filled with the fluid, the fluid flows through the first, second, third, and fourth slots 132, 134, 136, 138 and the first and second openings 142, 144 into the internal void 126 and is blocked from flowing out of the component by the sealing disk 182. Further in operation, to drain the component 108, the drain plug assembly 130 is removed from the retention nut 100. The fluid thus flows out of the component 108 through the first, second, third, and fourth slots 132, 134, 136, 138, the first and second openings 142, 144, and the internal void 126. It should be appreciated that because the first, second, third, and fourth slots 132, 134, 136, 138 and the first and second openings 142, 144 extend below the internal bottom 172, the component 108 may be thoroughly drained of fluid. Yet further in operation, a tool (not shown), e.g., pliers, may be used to squeeze the first and second snap wings 112, 114 towards one another to release and remove the retention nut 100 from the component 108.

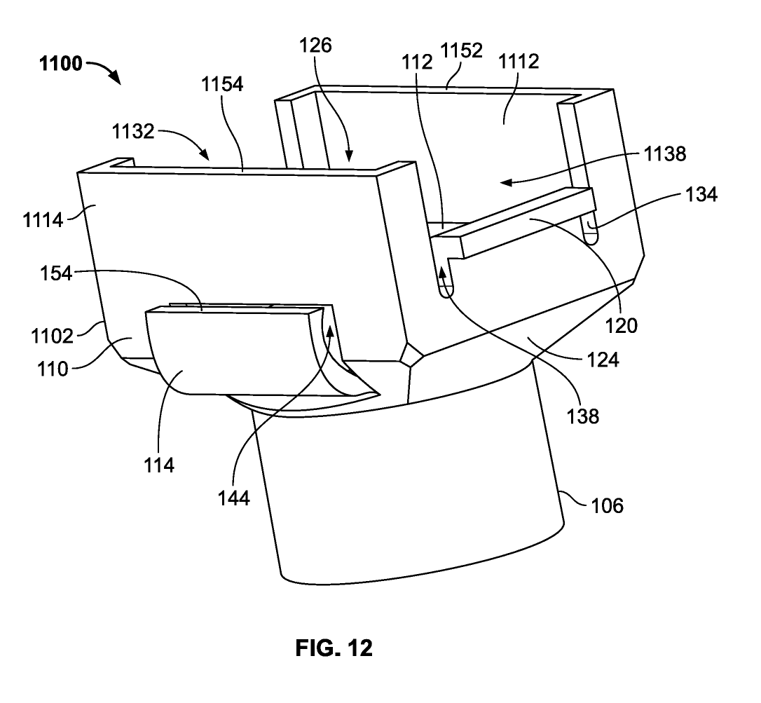

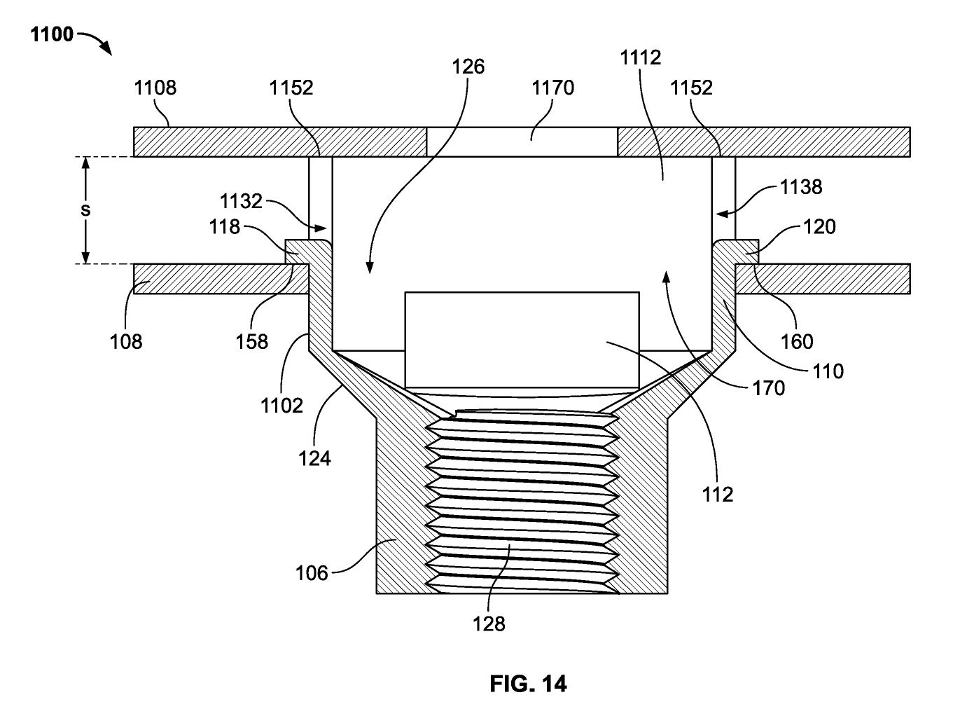

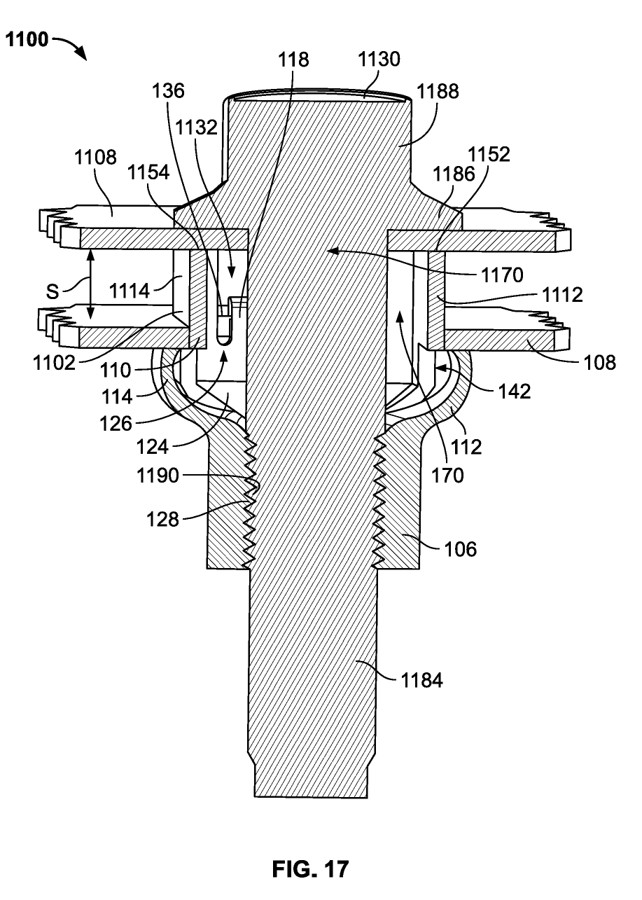

With reference to FIGS. 12-17, a second example retention nut 1100 includes a mating portion 1102 and the fastening portion 106. It should be understood that the second example retention nut 1100 is a variation on, and thus structurally similar to, the first example retention nut 100 of FIGS. 1-11. As shown in FIGS. 12-17, the mating portion 1102 is configured to snapably engage with the component 108 in the same manner as the first example retention nut 100 of FIGS. 1-11. The fastening portion 106 includes the internal threads 128 to threadably engage with a screw 1130, as shown in FIG. 17. Turning specifically to FIGS. 12 and 15-17, the mating portion 1102 includes the base 110, the first snap wing 112, the second snap wing 114, and the slope 124. Looking particularly at FIG. 14, the mating portion 1102 also includes the first flange tab 118 and the second flange tab 120. Thus, the second example retention nut 1100 has all the features of the first example retention nut 100 described above.

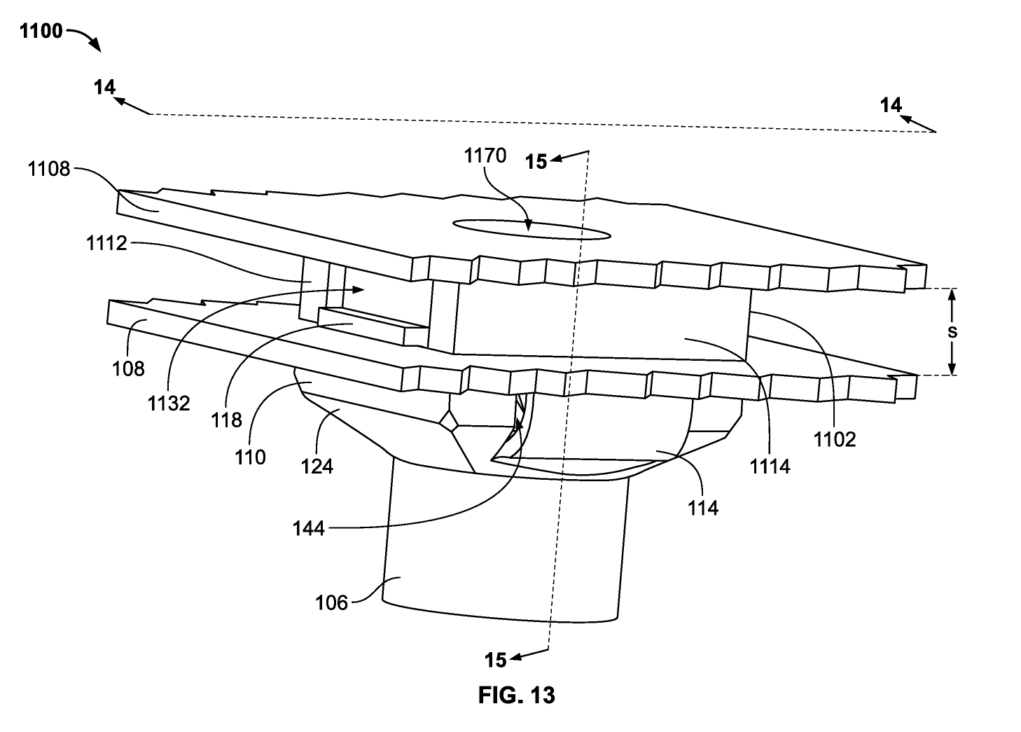

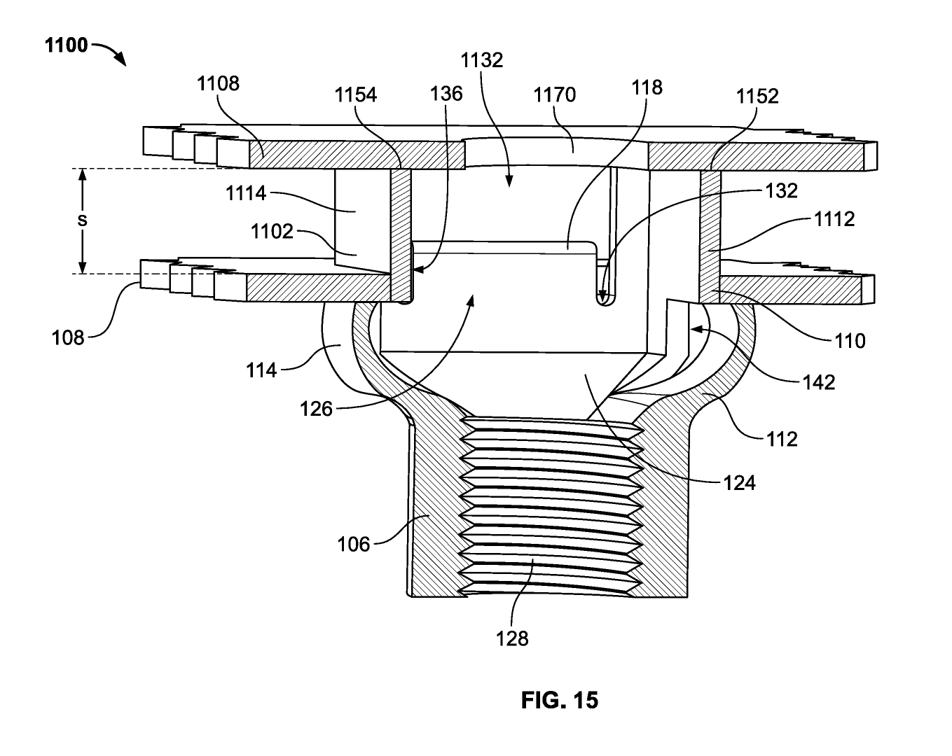

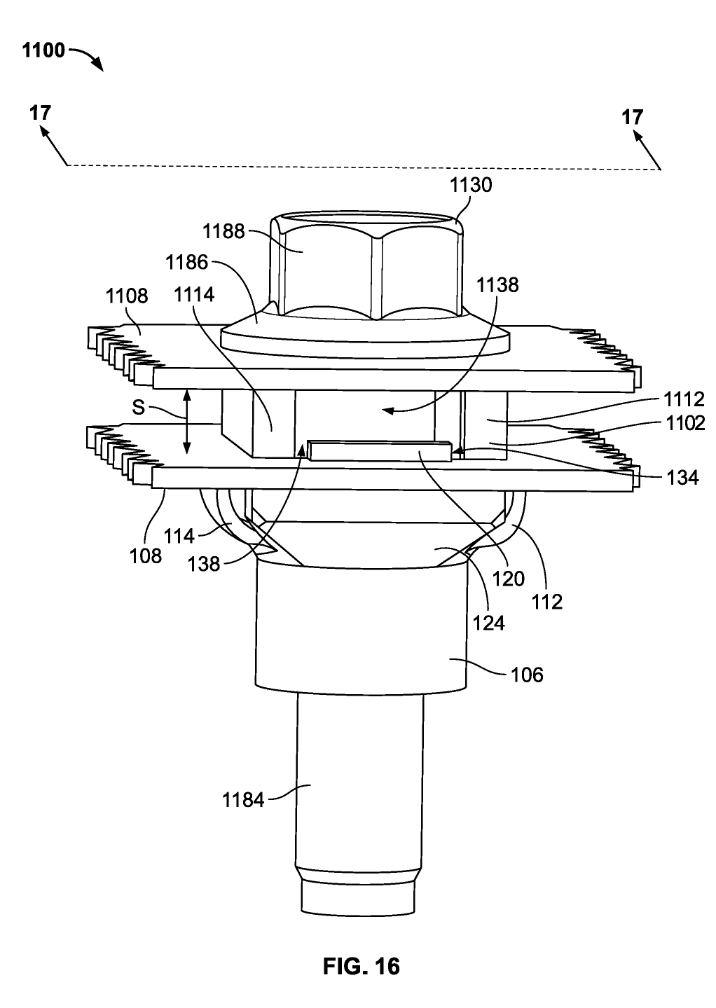

With reference to FIGS. 12-17, the mating portion 1102 additionally has a first spacer extension 1112 and a second spacer extension 1114. With specific reference to FIG. 12, the first and second spacer extensions 1112, 1114 extend away from the base 110 beyond the second flange tab 120. Similarly, with specific reference to FIG. 15, the first and second spacer extensions 1112, 1114 extend away from the base 110 beyond the first flange tab 118. Looking at FIGS. 12, 15, and 17, the first and second spacer extensions 1112, 1114 are opposite one another. Looking particularly at FIG. 15, the first spacer extension 1112 is aligned with the first snap wing 112. Additionally, the second spacer extension 1114 is aligned with the second snap wing 114. Thus, looking at FIGS. 13, 15, and 17, the first flange tab 118 is between the first and second spacer extensions 1112, 1114. Similarly, looking at FIGS. 12 and 16, the second flange tab 120 is between the first and second spacer extensions 1112, 1114.

With reference to FIGS. 12, 14, 15, and 17, the first spacer extension 1112 has a first end 1152. Further, the second spacer extension 1114 has a second end 1154. Turning specifically to FIG. 14, the second example retention nut 1100 is configured to engage a cover 1108 via the first and second ends 1152, 1154. The first end 1152 and the second end 1154 are generally coplanar. Thus, the spacer extension 1112, the first flange tab 118, and the second flange tab 120 define a spacing distance s between the first end 1152 and the first and second upper surfaces 158, 160. Additionally, looking specifically at FIG. 15, the second spacer extension 1114 and the second end 1154 also define the spacing distance s in the same manner as the first spacer extension 1112 and the first end 1152. It should be appreciated that the retention nut 1100 may be configured during manufacturing to define any spacing distance s. Thus, looking at FIGS. 14-17, the spacing distance s may be set to any desired value to, for example, ensure proper compression of an elastomer between the cover 1108 and the component 108 (not shown). Example elastomers include room-temperature-vulcanizing silicone, urethane, silicone rubber, gaskets, etc.

With reference to FIGS. 13 and 15, the first and second spacer extensions 1112, 1114 and the first flange tab 118 define a first spacer opening 1132. As shown in FIG. 15, the first spacer opening 1132 is in communication with the first slot 132 and the third slot 136. Similarly, with specific reference to FIGS. 12, 16, and 17 the first and second spacer extensions 1112, 1114 and the second flange tab 120 define a second spacer opening 1138. As shown in FIG. 12, the second spacer opening 1138 is in communication with the second slot 134 and the fourth slot 138. Additionally, the first and second spacer openings 1132, 1138 are in communication with the internal void 126.

With reference to FIGS. 13-15 and 17, the cover 1108 defines an opening 1170. Looking specifically at FIG. 17, the screw 1130 is sized to pass partially through the opening 1170 and engage the cover 1108. The screw 1130 includes a shank 1184, a compression flange 1186, a tightening cap 1188, and external threads 1190. The shank 1184 passes through the opening 1170. The compression flange 1186 is sized to overshadow the opening 1170 and contact the cover 1108.

With reference to FIGS. 13-17, in operation, the second example retention nut 1100 is inserted into and seated in the component 108 via the mating portion 1102 in the same manner as the first example retention nut 100 is inserted into and seated in the component 108 via the mating portion 102 described above and shown in FIGS. 5-11.

With reference to FIGS. 13-15 and 17, in operation, the cover 1108 is placed on the retention nut 1100 to align the opening 1170 with the fastening portion 106. Turning to FIGS. 16 and 17, further in operation, the screw 1130 is inserted through the cover 1108 and into the retention nut 1100 to spacingly join the cover 1108 with the component 108. Thus, the cover 1108 and the component 108 are assembled together and spaced the spacing distance s from one another via the retention nut 1100. Looking specifically at FIG. 17, in operation, the screw 1130 is threadably engaged with the fastening portion 106 via the external threads 1190 and the internal threads 128. As the screw 1130 is tightened via the tightening cap 1188, e.g., with a hex socket tool, the compression flange 1186 compresses the cover 1108 against the first and second ends 1152, 1154. Thus, the cover 1108 is disposed between the compression flange 1186 and the first and second ends 1152, 1154. Further, in operation, the first spacer extension 1112 is disposed between and the component 108 and the cover 1108. Similarly, in operation, the second spacer extension 1114 is also disposed between and the component 108 and the cover 1108. It should be appreciated that the first and second spacer extensions 1112, 1114 provide a hard stop to maintain the spacing distance s between the cover 1108 and the component 108. With reference to FIGS. 14 and 15, it should be understood that the retention nut 1100 may be used with any threaded fastener in addition or alternatively to the screw 1130 depicted in FIGS. 16 and 17.

From the foregoing, it will be appreciated that the above disclosed first and second example retention nuts 100, 1100 obviate the need to weld and/or crimp a drain nut onto a component and may thus aid in reducing associated manufacturing costs and distorted and/or damaged component waste. Further, because the height difference h may be tuned by adjusting the first and second snap wings 112, 114 and the first and second flange tabs 118, 120 during manufacture, the first and second example retention nuts 100, 1100 may be used across a wide range of component material thicknesses and applications. Yet further, because the spacing distance s may be tuned by adjusting the first and second spacer extensions 1112, 1114 during manufacture, the second example retention nut 1100 may be used across a wide range of spaced-component assembly applications. Additionally, because the first and second snap wings 112, 114 and the first and second flange tabs 118, 120 securely fix the first and second example retention nuts 100, 1100 in the component 108, loss of the first and second example retention nuts 100, 1100 and associated unintentional fluid drain from the component 108 may be prevented. The retention nut 100 may thus aid in preventing damage to a vehicle associated with a lack of lubricating oil.

While various spatial and directional terms, such as top, bottom, lower, mid, lateral, horizontal, vertical, front and the like may be used to describe examples of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present disclosure. It is understood that the examples disclosed and defined herein extend to all alternative combinations of two or more of the individual features mentioned or evident from the text and/or drawings. All of these different combinations constitute various alternative aspects of the present disclosure. The examples described herein explain the best modes known for practicing the disclosure and will enable others skilled in the art to utilize the disclosure. The claims are to be construed to include alternative examples to the extent permitted by the prior art.

What is claimed is:

1. A retention nut, comprising:
a fastening portion comprising internal threads; and
a mating portion connected to the fastening portion, the mating portion comprising a snap wing.

2. The retention nut of claim 1, wherein the mating portion comprises a base and a slope.

3. The retention nut of claim 2, wherein
the fastening portion is connected to the slope; and
the slope provides a transition from the base to the fastening portion.

4. The retention nut of claim 2, wherein the snap wing extends outwardly from the slope.

5. The retention nut of claim 2, wherein the slope and the base define an opening.

6. The retention nut of claim 2, wherein the base defines a slot.

7. The retention nut of claim 1, wherein the mating portion comprises a flange tab.

8. The retention nut of claim 7, wherein:
the snap wing has an end;
the flange tab has an upper surface; and
the end and the upper surface define a height difference between the end and the upper surface.

9. The retention nut of claim 7, wherein the snap wing and the flange tab are configured to snapably capture a component between the snap wing and the flange tab.

10. The retention nut of claim 7, wherein:
the snap wing is a first snap wing; and
the flange tab is a first flange tab,
wherein the retention nut further comprises a second snap wing opposite the first snap wing and a second flange tab opposite the first flange tab.

11. The retention nut of claim 1, wherein the mating portion is non-circular.

12. The retention nut of claim 11, wherein the mating portion is configured to mate with a correspondingly non-circular opening defined by a component.

13. The retention nut of claim 1, wherein:
the mating portion and the fastening portion have an exterior,
the mating portion and the fastening portion define an internal void,
the mating portion defines one or more of an opening and a slot, and
the internal void is in fluid communication via one or more of the opening and the slot.

14. The retention nut of claim 13, wherein the mating portion defines two slots and comprises a flange tab extending outwardly between the two slots.

15. The retention nut of claim 1, wherein the snap wing is arcuate.

16. A retention nut, comprising:
an internally threaded fastening portion;
a snap wing connected to the fastening portion; and
a flange tab connected to the fastening portion.

17. The retention nut of claim 16, wherein:
the snap wing is a first snap wing, and
the flange tab is a first flange tab,
wherein the retention nut further comprises a second snap wing opposite the first snap wing and a second flange tab opposite the first flange tab.

18. The retention nut of claim 16, wherein the snap wing and the flange tab are configured to snapably capture a component between the snap wing and the flange tab.

19. A retention nut, comprising:
a barrel;
a transitional slope connected to the barrel;
a snap wing extending outwardly from the transitional slope;
a non-circular base connected to the transitional slope; and
a flange tab extending outwardly from the base.

20. The retention nut of claim 19, wherein the snap wing and the flange tab are configured to snapably capture a component between the snap wing and the flange tab.
